(19) United States
(12) Patent Application Publication
(10) Pub. No.: US 2026/0369673 A1
(43) Pub. Date: Nov. 19, 2026

(54) METHOD FOR PRODUCING MATERIAL LAYER, AND METHOD FOR PRODUCING PRECURSOR OF SOLID-STATE BATTERY

(71) Applicant: CANON KABUSHIKI KAISHA, Tokyo (JP)

(72) Inventors: HIROSHI TANIUCHI, Kanagawa (JP); HIROKAZU USAMI, Kanagawa (JP); IKUO NAKAZAWA, Kanagawa (JP); KENTA KUBO, Kanagawa (JP); YOHEI MASADA, Tokyo (JP); TAKAHARU AOTANI, Tokyo (JP); MITSUYOSHI ARAKAWA, Tokyo (JP)

(21) Appl. No.: 19/740,581

(22) Filed: Jul. 14, 2026

Related U.S. Application Data
(63) Continuation of application No. PCT/JP2025/001866, filed on Jan. 22, 2025.

(30) Foreign Application Priority Data
Jan. 25, 2024 (JP) 2024-009194

(51) Int. Cl. H01M 10/0562

(52) U.S. Cl. CPC H01M 10/0562; H01M 2300/0097

(57) ABSTRACT

A method of producing a material layer, comprising: a first step of forming a mask part on a part of a surface of a first substrate; a second step of arranging first particles on the surface of the first substrate; a third step of removing the mask part from the first substrate; a fourth step of transferring the first particles to a second substrate; and a fifth step of arranging second particles on at least a part of a region of a surface of the second substrate where the first particles are not arranged.

### CROSS-REFERENCE TO RELATED APPLICATIONS

This application is a Continuation of International Patent Application No. PCT/JP2025/001866, filed Jan. 22, 2025, which claims the benefit of Japanese Patent Application No. 2024-009194, filed Jan. 25, 2024, both of which are hereby incorporated by reference herein in their entirety.

### BACKGROUND

### Field of the Technology

The present invention relates to a method of producing a material layer and a method of producing a precursor of a solid-state battery.

### Description of the Related Art

In recent years, various new production methods using additive manufacturing techniques have been developed. However, techniques for preparing functional structures by designing and arranging a plurality of material particles are difficult to achieve and have not been widely realized. Particularly, there are not many techniques for designing and arranging particles in their particulate form.

For example, techniques for arranging toner particles using electrophotographic techniques have become generally widespread. However, the proportion of pigments that can function as functional materials in the toner is low, and it is difficult to exhibit functionality other than color. In addition, electrostatic screen printing is a technique capable of patterning particles without using a binder. However, it is difficult to increase resolution because it is necessary to create a gap between a plate and a substrate. In addition, it is difficult for both techniques to produce a thin film close to a single particle layer, and they cannot achieve high resolution in the lamination direction.

On the other hand, Japanese Patent Laid-Open No. 2019-137060 discloses a method of producing a material layer including a first step of arranging first particles in a pattern on a substrate and a second step of arranging second particles in a region on the substrate where the first particles are not arranged, wherein the second step is a step of rubbing a supporting material supporting the second particles against the substrate on which the first particles are arranged.

### SUMMARY

However, with the advancement of techniques, there is a strong demand not only for improvement in absolute performance, but also for increased production efficiency, that is, stabilization of production quality and improvement in yield rate. The inventors have reviewed the prior art in this regard, and found that there are the following issues.

In the method of producing a material layer in Japanese Patent Laid-Open No. 2019-137060, a particle pattern is prepared using an intaglio plate and this is transferred to an adhesive surface of a substrate. However, when a pattern of particles 102 is prepared on an intaglio plate 101, if unnecessary particles 102-1 also adhere onto convex parts, particles may adhere to unintended locations (FIG. 1A), or particles 102-1 on the convex parts of the intaglio plate come into contact with an adhesive part of the substrate during transfer to second substrates 11, and thereby the transfer load applied to essential particles inside the intaglio plate is reduced (FIG. 1), and as a result, it has been found that there are points needing improvement such as cases in which transfer failure occurs.

The present disclosure provides a method of producing a material layer that contributes to stabilizing production quality and improving the yield rate. In addition, the present disclosure provides a method of producing a precursor of a solid-state battery that contributes to stabilization of production quality and improving the yield rate.

The present disclosure provides a method of producing a material layer, comprising: a first step of forming a mask part on a part of a surface of a first substrate; a second step of arranging first particles on the surface of the first substrate; a third step of removing the mask part from the first substrate; a fourth step of transferring the first particles to a second substrate; and a fifth step of arranging second particles on at least a part of a region of a surface of the second substrate where the first particles are not arranged.

Further, the present disclosure provides a method of producing a precursor of a solid-state battery, comprising the method of producing the material layer of the present disclosure,
wherein the second substrate is a resin substrate.

Features of the present disclosure will become apparent from the following description of embodiments with reference to the attached drawings. The following description of embodiments is described by way of example.

### BRIEF DESCRIPTION OF THE DRAWINGS

FIGS. 1A to 1D are diagrams illustrating one embodiment of the present disclosure.

FIG. 2 is an image diagram showing a method of producing a material layer according to one aspect of the present disclosure.

FIG. 3 is a diagram illustrating a material layer preparation device.

FIGS. 4A to 4H are diagrams illustrating respective steps according to one aspect of the present disclosure.

FIGS. 5A to 5D are diagrams illustrating respective steps according to one aspect of the present disclosure.

FIGS. 6A and 6B are diagrams illustrating a laminate according to one aspect of the present disclosure.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ. In the case where XX represents a group, a plurality of members may be selected from XX, and the same is true for YY and ZZ.

The present disclosure relates to a method of producing a material layer. The method of producing a material layer includes a first step of forming a mask part on a part of a surface of a first substrate. The method also includes a second step of arranging first particles on the surface of the first substrate. The method also includes a third step of removing the mask part from the first substrate. The method also includes a fourth step of transferring the first particles to a second substrate. The method also includes a fifth step of arranging second particles on at least a part of a region of a surface of the second substrate where the first particles are not arranged.

The inventors conducted studies and as a result, found that the above problems can be solved when the method of producing a material layer includes the above steps.

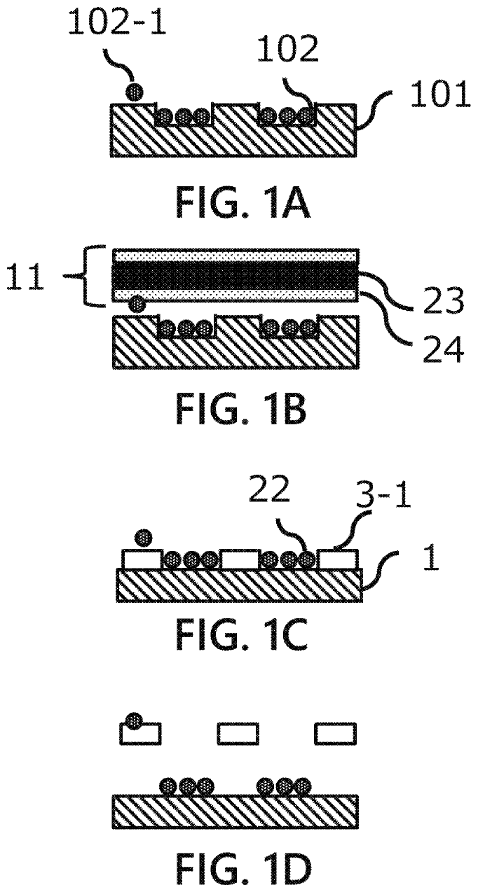

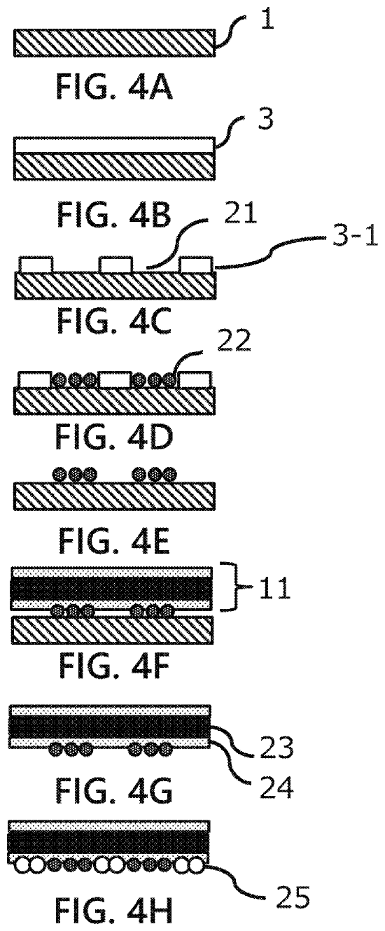

That is, according to the above steps, even if particles adhere to a mask part 3-1, the adhered particles 102-1 can also be removed together with the removal of the mask part 3-1 (FIGS. 1C and 1D). That is, it is possible to reduce the amount of unnecessary particle adhesion that may occur in areas which are not image parts according to the design. Then, after the mask part 3-1 is removed, first particles 22, which have been patterned, remain only on a first substrate 1. Therefore, during transfer, the particle pattern comes into direct contact with the adhesive layer, and thus sufficient transfer pressure is applied (FIG. 4F), and the pattern can be formed stably. This is thought to be because the particle transfer rate when the first particles are transferred from the first substrate to the second substrate is improved.

In addition, when the pattern in which the convex part of the intaglio plate is wide is formed, the contact area with the adhesive part of the substrate also becomes large, which may make separation after transfer difficult. However, according to the above steps, since the mask part is removed and only the particle pattern comes into direct contact with the adhesive layer, separation after transfer becomes easy.

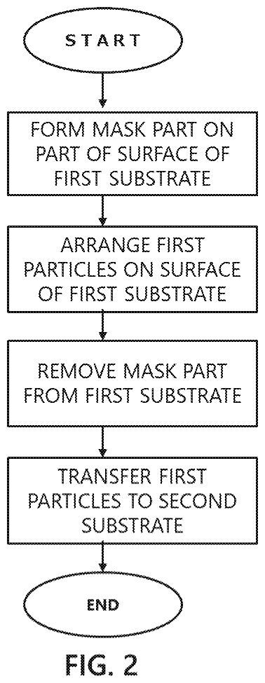

FIG. 2 is an image diagram showing a method of producing a material layer according to one aspect of the present disclosure.

In addition, FIGS. 4A to 4H are diagrams illustrating respective steps of the present disclosure. A mask layer 3 is attached to the first substrate 1 (FIGS. 4A and 4B). Then, an opening 21 (a region where the mask part is not formed) is formed in the mask layer 3 (FIG. 4C). That is, the mask part 3-1 is formed on a part of the surface of the first substrate (first step). In addition, the opening 21 is filled with first particles 22 (FIG. 4D). That is, the first particles are arranged on the surface of the first substrate (second step). In addition, the mask part is removed from the first substrate (third step, FIG. 4E). Furthermore, a second substrate 11 is pressed against the first particles 22 (FIG. 4F), the first particles are transferred to the second substrate, and the particle pattern is transferred (fourth step, FIG. 4G). In addition, second particles are arranged on at least a part of a region of the surface of the second substrate 11 where the first particles are not arranged (fifth step, FIG. 4H).

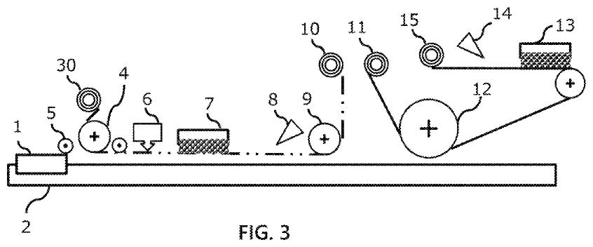

FIG. 3 is an example of a material layer preparation device for implementing a method of producing a material layer according to one aspect of the present disclosure.

The material layer preparation device includes a transport device 2 that transports the first substrate 1 between steps, as a center, a mask layer attachment unit including a mask layer supply unit 30, a pressing roller 4, and a wet sponge roller 5, a mask separation unit including a mask preparing unit (UV laser 6), a first particle supply unit 7, an air blower 8, a separation roller 9, and a winding device 10, a particle pattern transfer unit including a second substrate (not shown), a pressure roller 12, and a winding device 15, an air blower 14, and a second particle supply unit 13. By sequentially performing processing with these units, the method of producing a material layer of the present disclosure is implemented.

In FIG. 3, the material layer preparation device is configured to process respective steps in a series, but the configuration is not limited thereto, and the steps may be appropriately divided.

Hereinafter, embodiments of the present disclosure will be described according to the steps, taking an aspect using the material layer preparation device in FIG. 3 as an example.

First, the first substrate is not particularly limited, and is preferably a support having a smooth surface. As for the support having a smooth surface, as long as the surface to which the mask layer is attached is smooth, the other surface configuration can be set to an optimal shape according to the device.

The material of the first substrate may be the same as or different from that of the mask layer. In order to improve the patterning accuracy, it is preferable that the first substrate be resistant to deformation. Particularly, when the first substrate deforms during mask removal, the formed first particle pattern is disturbed, and thus high rigidity is desirable. When the rigidity of the first substrate is insufficient, a reinforcing member can be additionally provided on the back surface (the surface opposite to the side on which the mask part is formed) of the first substrate.

In addition, it is preferable that the first substrate have high wear resistance against the particle material used because this allows repeated use. When the first substrate wears, not only is its repetitive usability reduced, but the worn material may also be incorporated into the material layer as impurities.

Specific materials for the first substrate are not particularly limited, and may be selected according to the particles used. Examples thereof include resins such as a polyimide resin, a polyacetal resin, and a polyester resin, metals such as aluminum, stainless steel, and invar alloys, as well as glass and ceramics. Glass is particularly preferable because it has high surface smoothness.

In addition, the shape of the first substrate is not particularly limited as long as it is a shape that allows at least line-contact pressurization. For example, a flat shape, a roller shape, a belt shape may be used. Among these, a flat shape is preferable.

In the material layer preparation device in FIG. 3, a flat glass is used as the first substrate, and this is horizontally moved by the transport device 2.

In the first step, a mask part is formed on a part of a surface of a first substrate 1. The means for forming the mask part is not particularly limited, and may include, for example, a step of providing the mask layer 3 on the first substrate and a step of forming the opening 21 in the mask layer 3 to form the mask part 3-1.

The step of providing the mask layer 3 on the first substrate 1 is not particularly limited, and may include, for example, a step of attaching the mask layer 3 to the first substrate 1. The means for attaching the mask layer 3 to the first substrate 1 is not particularly limited, and in the material layer preparation device in FIG. 3, the mask layer 3 is attached by applying pressure with the pressing roller 4 having elastic rubber on its surface.

When a smooth mask layer is attached to the first substrate 1, if it is attached while removing an air layer, it can be attached only with the first substrate 1 and the mask layer 3 due to the principle of vacuum adhesion.

In addition, the first step preferably includes a step of increasing a fixing force between the mask layer 3 and the first substrate 1. Such steps are not particularly limited, and known techniques can be widely applied. Examples thereof include a step of forming a water film, a step of heating and pressurizing, a step of using an external force such as static electricity or a magnetic force, and a step of providing an adhesive layer on a mask layer. Specifically, the steps are as follows.

The material layer preparation device in FIG. 3 includes the wet sponge roller 5 for forming a thin water film on the surface of the first substrate 1 prior to attaching of the mask layer 3. When a liquid layer such as a thin water film is provided between the mask layer 3 and the first substrate 1, the water film adsorption effect can be obtained. That is, it is more preferable that the first step include a step of forming a water film on the surface of the first substrate.

When the mask is formed of a resin film, the first step preferably includes a step of heating and pressurizing the mask layer. By performing attaching through heating and pressurizing, the flexibility of the mask layer can be increased and the adhesion to the first substrate can be improved. When the mask layer is formed of a magnetic material, a magnetic force or the like can be used.

In addition, in the step of providing the mask layer 3 on the first substrate 1, a plurality of mask layers may be provided in a stacked manner. In this case, the material of the mask layer may be of only one type or two or more types may be used in combination.

The thickness of the mask layer 3 is not particularly limited, and may be, for example, 1 to 100 μm or 2 to 50 μm. In addition, it is desirable that the thickness of the mask layer 3 be approximately uniform. The thickness of the mask layer 3 defines the depth of the opening 21, and the opening 21 determines the thickness of the particle layer. Therefore, it is desirable that the thickness of the mask layer 3 be selected according to the design of the thickness of the particle layer. For example, when a mask layer with a thickness corresponding to a desired particle size is used, a particle pattern in which the particle layer is substantially a single layer can be formed. That is, the thickness of the mask layer is preferably substantially equal to the volume average particle diameter of the first particles, and for example, the thickness (μm) of the mask layer is preferably 0.7 to 1.3 times the volume average particle diameter (μm) of the first particles.

In terms of attachment and removal, the mask layer is easier to handle if it is flexible. In addition, in order to make the opening fine and increase the planar resolution, a material with good drillability is desirable.

For the above reasons, the thickness of the mask part is not particularly limited, and may be, for example, 1 to 100 μm or 2 to 50 μm. In addition, it is desirable that the thickness of the mask part be approximately uniform.

Specific materials for the mask layer are not particularly limited, and it is desirable to select the materials according to the particles used and the means for forming the opening used. When the mask layer is to be used repeatedly, a metal foil such as aluminum, stainless steel, or invar is preferable, and when the mask layer is disposable, a resin film such as polyimide, polyacetal, or polyester is preferable. Particularly, a polyester resin is suitable because of its favorable thermal processability and ease of thinning. In addition, when the mask layer is held with a magnetic force, a magnetic material is preferable, and a ferromagnetic material is more preferable. Therefore, a metal foil is preferable. Specific materials for the mask part are also not particularly limited, and the above materials can be used for the same reasons as the mask layer.

In the material layer preparation device in FIG. 3, a polyester resin film wound in a roll form is used. In addition, for example, the mask layer can also be formed using a sheet-cut film or coating/drying with a processing solution.

The shape of the mask part is not particularly limited, and may be, for example, a stripe shape or a honeycomb shape. In the case of a stripe shape, the width of the opening is not particularly limited, and may be 1 to 200 μm or 2 to 100 μm. In addition, the width of the mask part may be 1 to 200 μm or 2 to 100 μm.

When the first step includes a step of forming the opening 21 in the mask layer 3, the step of forming the opening is not particularly limited, and known techniques can be used. Examples thereof include a method of forming a mask layer using a photosensitive resin and forming an opening by photolithography. In addition, a step of providing the mask layer 3 on the first substrate and a step of forming the opening 21 in the mask layer 3 can be performed simultaneously. Examples thereof include a method of printing a mask part using inks with high film-thickening properties such as PVA or vinyl materials and a method of printing a mask part by an electrophotographic technique or an inkjet technique.

In the material layer preparation device in FIG. 3, a UV laser 6 is used as a means for creating an opening in the mask. When the UV laser is used, the degree of freedom in pattern is high. In addition, by increasing the difference in wavelength absorption between the material of the first substrate and the material of the mask layer, such as by using glass for the first substrate and a resin film for the mask layer, only the mask layer can be removed without damaging the first substrate. When the UV laser is used, the adhesiveness of the edge of the mask part to the first substrate increases due to heat generated during processing, thereby making it possible to reduce unintended peeling of the mask layer.

In the material layer preparation device in FIG. 3, the mask layer is attached to the first substrate 1, and the opening is then formed. Alternatively, a mask part may be formed by attaching a mask layer in which the opening has been formed in advance.

In the second step, the first particles 22 are arranged on the surface of the first substrate 1. The method of arranging the first particles 22 is not particularly limited, and can be selected according to desired particle properties and the particle density for the pattern. The second step is preferably a step of arranging the first particles 22 in a region of the surface of the first substrate 1 where the mask part 3-1 is not formed. The region where the mask part 3-1 is not formed is a design image part, and is a region where the first particles 22 are expected to be arranged. In addition, it can be said that the opening 21 is a region of the surface of the first substrate 1 where the mask part is not formed.

In addition, it is preferable to also consider the fixing force of the mask part to the first substrate. If the shear that can occur when arranging the first particles is excessive, the mask part may be separated. In the material layer preparation device in FIG. 3, a magnetic particle rubbing means is used. The magnetic particle rubbing means is excellent in the following respects. That is, by controlling the magnetic force of a sliding magnet (not shown) arranged on the back surface (surface opposite to the side on which the mask layer is provided) of the first substrate, it is possible to easily control the shear during particle arrangement.

According to the present disclosure, excess particles on the mask part can be removed together with the removal of the mask part. Therefore, as the method of arranging first particles, low-shear application methods such as a method using a forward-rotating roller and a vibrational powder flow method can be used favorably. In addition, one type of the method of arranging first particles may be used alone, or a plurality thereof may be used in combination.

After the first particles are arranged, a step of removing excess first particles may be performed. As described above, in the present disclosure, excess first particles on the mask part can be removed together with the removal of the mask part. However, when particles filled into the opening are excessive, the first particles may slide off during the transfer step. In this case, the particle pattern may be disturbed or the amount of unnecessary particle adhesion may increase. The material layer preparation device in FIG. 3 includes the air blower 8 as a means for removing excess first particles after the first particles 22 are arranged. The air blower is preferable in order to remove excess particles. Other known techniques such as flexible brushes and low-adhesive rollers can be applied as means for removing excess first particles.

In the third step, the mask part 3-1 is removed from the first substrate 1. The method of removing the mask part 3-1 from the first substrate 1 is not particularly limited, and examples thereof include a method of separating the mask part 3-1 from the first substrate 1.

As the method of removing the mask part 3-1 from the first substrate 1, in the material layer preparation device in FIG. 3, a method of winding the mask part 3-1 in a continuous film form using the separation roller 9 and the winding device 10 is used. As other methods, for example, in the case of a sheet form, a method of lifting the mask peripheral part by vacuum adsorption or a method of providing a handle part at the mask end in advance and mechanically lifting it may be used. In addition, static electricity may be generated when the resin material mask part is removed, and the particle pattern is disturbed. Therefore, it is preferable to take countermeasures against static electricity depending on the situation.

In the fourth step, the first particles are transferred to the second substrate.

After the mask part 3-1 is removed, the first particles 22 remain on the first substrate 1 alone (FIG. 4E). Therefore, by bringing the second substrate having an adhesive layer on its surface into contact under pressure with the first particles and transferring the first particles, a second substrate having the first particles on its surface can be obtained. The second substrate is not particularly limited, and can be freely selected depending on the purpose, and for example, the material of the first substrate described above can be used. In the material layer preparation device in FIG. 3, a second substrate in the form of a so-called double-sided tape in which an adhesive layer is previously formed on both surfaces of abase substrate is used in a roll state. That is, the second substrate may be an adhesive tape or a double-sided tape.

The method of obtaining a second substrate having an adhesive layer is not particularly limited, and for example, a mechanism for applying an adhesive to the surface of the second substrate may be provided within the device.

The material used for the adhesive is not particularly limited, and examples thereof include an acrylic adhesive, a urethane adhesive, and a silicone adhesive.

In addition, when the second substrate is formed of only an adhesive phase, it may stretch due to the force applied during handling such as when separating it from an intermediate transfer member. Therefore, it is desirable for the second substrate to have a multilayer structure including a base substrate made of a material resistant to stretching and an adhesive layer. As the material of the base substrate, resin films such as a polyester resin, an acrylic resin, a polypropylene resin, and a polyimide resin, and metal foils such as aluminum and copper can be used. A resin film is preferable in consideration of removing the second substrate by heating or the like.

The pressure roller 12, which can be used to transfer the first particles to the second substrate, is preferably an elastic body. When it is an elastic body, the transfer pressure is stably applied, and as a result, the transfer rate becomes more stable. In the material layer preparation device in FIG. 3, a configuration using one elastic roller is used, but the present invention is not limited thereto. A configuration using a plurality of elastic rollers, belt pressurization, or a means for performing surface pressurization by batch processing can also be applied. The particles on the first substrate are in direct contact with the adhesive layer surface on the second substrate. Therefore, there is little resistance when the first substrate is separated from the second substrate after transfer, and the shear applied to the second substrate is also small. As a result, the substrate is less likely to stretch and less likely to wrinkle.

In the fifth step, the second particles are arranged on at least a part of a region of the surface of the second substrate where the first particles are not arranged.

The material layer preparation device in FIG. 3 includes the second particle supply unit 13 for supplying second particles to the second substrate on which the first particles are arranged. Therefore, the second particles can be arranged in a region where the first particles are not arranged. In a part of the adhesive layer on the second substrate, the first particles are arranged. Therefore, the second particles selectively adhere to the exposed part of the adhesive layer other than those where the first particles are arranged. As the means for arranging the second particles, those described in the section of the first particles can be used. When a material layer containing no second particle is produced, the method of producing a material layer does not need to include the fifth step. That is, the method of producing a material layer may include the first step, the second step, the third step, and the fourth step.

The second particles used may be the same as or different from the first particles.

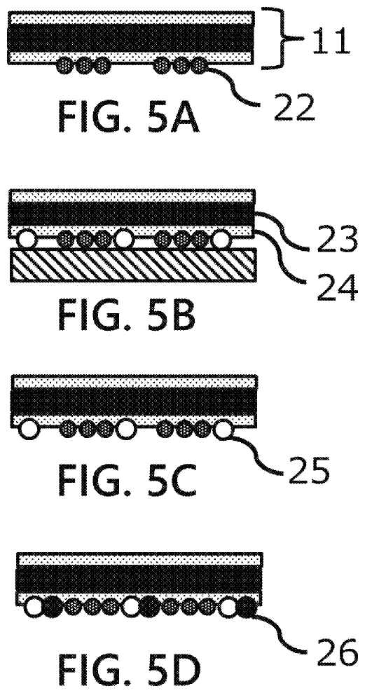

The material layer preparation device in FIG. 3 shows an example using two types of particles: first particles and second particles. However, in the present disclosure, a pattern of three or more types of particles can also be prepared. First, the first particles 22 on the first substrate are transferred to the second substrate 11 (FIG. 5A). In FIGS. 5A to 5D, the second substrate includes a base substrate 23 and an adhesive layer 24 on the base substrate. Then, by the same means as the first particles, third particles 25 are arranged on another first substrate (FIGS. 5B and 5C). Then, this is transferred to the second substrate 11 and second particles 26 are then supplied. Thereby, the second particles 26 selectively adhere to the exposed part other than those where the first particles 22 and the third particles 25 are arranged (FIG. 5D). Therefore, by using a mask part designed with a shifted opening pattern, it is possible to obtain a pattern composed of more diverse types of particles. That is, it is preferable that the first step be performed two or more times and the shapes of the mask parts formed in respective steps be different from each other. Here, the third particles used can be the same as first particles to be described below.

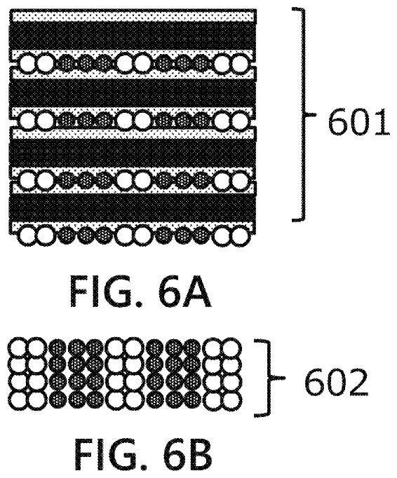

In the material layer preparation device in FIG. 3, a single-layer particle pattern can be prepared. On the other hand, these single-layer particle patterns can be laminated to form a laminate. That is, a laminate may be produced by a step of laminating material layers to form a laminate. The second substrate having the particle pattern formed thereon, which is prepared by the material layer preparation device in FIG. 3, is in the form of a double-sided tape. Therefore, sheets can be laminated using an adhesive layer on the side opposite to the layer on which the particle pattern is formed (FIG. 6A). That is, a laminate 601 can be molded by laminating a plurality of second substrates on which the particle layer is formed. Here, when the adhesive layer is provided on the side opposite to the layer on which the particle pattern is formed, the substrates adhere to each other, and the strength of the laminate increases. As a result, it is possible to minimize displacement between the substrates. In addition, the particle layer between the substrates is inserted between the upper and lower adhesive layers, and it is possible to minimize displacement of the arrangement during storage or the like. The number of layers in the laminate is not particularly limited.

In addition, the second substrate can be removed using the difference in properties between the particles used and the second substrate, and a patterned laminate (three-dimensional object 602) composed of only particles can be obtained (FIG. 6B). That is, the three-dimensional object may be produced by a step of removing the second substrate from the laminate and molding the three-dimensional object containing the particles. The method of removing the second substrate is not particularly limited, and for example, a patterned laminate composed of only particles can be obtained by forming a material layer using a resin material as the second substrate, and degreasing a laminate formed of the material layer at a high temperature.

In addition, the internal porosity of the ceramic structure can be controlled by using a second substrate containing ceramic particles and heat-degreasing particles.

High-temperature degreasing conditions are not particularly limited, and it is preferable to perform heating at a temperature equal to or higher than the thermal decomposition temperature of the second substrate, and it is preferable to perform heating at a temperature lower than the thermal decomposition temperature of each particle layer in the patterned laminate. The temperature at which the laminate is heated is preferably from 200 °C to 1,000 °C, more preferably from 400 °C to 800 °C, particularly preferably from 450 °C to 800 °C, and especially preferably from 450 °C to 650 °C. It is preferable to maintain the sintering temperature for 30 minutes or longer and it is more preferable to maintain the sintering temperature for 1 hour or longer. In addition, the upper limit is not particularly limited, and may be, for example, 3 hours or shorter or 2 hours or shorter. For example, it is preferable to maintain the sintering temperature for 30 minutes to 3 hours and 1 hour to 2 hours.

The thermal decomposition temperature is the temperature at which the weight of a material begins to decrease when the temperature is gradually raised under an atmosphere during heating in a sintering device. Therefore, when the laminate is heated at a temperature equal to or higher than the thermal decomposition temperature of the second substrate, the second substrate in the laminate can be decomposed, the weight thereof can be reduced, and the second substrate can be removed from the laminate.

While the present invention has broad applicability to functional materials, battery modules are particularly suitable application fields. Higher performance of battery materials is expected to be achieved by functionally arranging the material of the electrode layer and efficiently arranging ions and electron paths. Among these, all-solid-state batteries, which do not use an electrolytic solution, exhibit a significant effect of functionally arranging the positive and negative electrode materials, the solid electrolyte material and the like.

The first particles are not particularly limited, and desired resin particles, inorganic particles and the like can be used. Examples of resin particles include (meth)acrylic resin particles, urethane resin particles, and ester resin particles. When the method of producing a material layer of the present disclosure is used as a method of producing a precursor of a solid-state battery, for example, it is preferable to include at least one of active material particles and solid electrolyte particles.

The active material particles are not particularly limited, and known particles can be used. For example, lithium-containing complex oxides can be used. Specific examples thereof include Li—Co oxide-based active material particles such as LiCoO₂ (lithium cobaltate), active material particles such as LiMO₂ (M is one element selected from the group consisting of Ni, Mn, and Co), Li—PO₄ oxide-based active material particles, lithium vanadium compounds (Li₃V₂(PO₄)₃, LiVOPO₄), and olivine-type phosphate compounds (LiMPO₄ (M is one or more elements selected from the group consisting of Co, Ni, Mn, Fe, Mg, V, Nb, Ti, Al, and Zr)). In addition, lithium-free active material particles may be used. Specific examples thereof include metal oxides (MnO₂, V₂O₅, etc.) and fluorides (FeF₃, VF₃, etc.).

Among these, it is preferable to include Li—Co oxide-based active material particles and Li—PO₄ oxide-based active material particles.

In addition, negative electrode active material particles such as graphite, Si, and lithium titanate (LTO) can be used.

Solid electrolytes are not particularly limited, and known electrolytes can be used. Examples thereof include Li—B oxide-based solid electrolyte particles, Li—Yb oxide-based solid electrolyte particles, NASICON-type solid electrolyte particles (LiAlTi(PO₄)₃, LiAlGe(PO₄)₃, etc.), and Li—P—O-based solid electrolyte particles (Li₃PO₄, LiPON (particles in which some O atoms of Li₃PO₄ are replaced with N), etc.). Among the above solid electrolyte particles, it is preferable to include Li—B oxide-based solid electrolyte particles and Li—Yb oxide-based solid electrolyte particles.

The second particles are not particularly limited, and like the first particles, desired resin particles, inorganic particles and the like can be used. When the method of producing a material layer of the present disclosure is used as a method of producing a precursor of a solid-state battery, for example, the second particles preferably include at least one of active material particles and solid electrolyte particles. Specifically, the active material particles, solid electrolyte particles and the like described above for the first particles can be used.

The first particles and the second particles may each be used alone as one type or a plurality of types thereof may be used in combination. When a plurality of types thereof are used in combination, a premix obtained by mixing a plurality of types of particles in advance may be used. The surface of the particles may be subjected to a surface treatment or coating.

The method of producing a material layer of the present disclosure can be used as a method of producing a precursor of a solid-state battery. That is, the method of producing a precursor of a solid-state battery includes a first step of forming a mask part on a part of a surface of a first substrate, a second step of arranging first particles on the surface of the first substrate, a third step of removing the mask part from the first substrate, a fourth step of transferring the first particles to a second substrate, and a fifth step of arranging second particles on at least a part of a region of a surface of the second substrate where the first particles are not arranged. Here, the obtained material layer corresponds to a precursor of a solid-state battery. When the method of producing a material layer of the present disclosure is used as a method of producing a precursor of a solid-state battery, the amount of unnecessary particle adhesion is reduced, the particle transfer rate when the first particles are transferred to the second substrate is improved, and the variation range of the electrical resistance value to be described below is reduced. When a solid-state battery precursor containing no second particles is produced, the method of producing a precursor of a solid-state battery does not need to include the fifth step. That is, the method of producing a precursor of a solid-state battery may include the first step, the second step, the third step, and the fourth step.

When the method of producing a material layer of the present disclosure is used as a method of producing a precursor of a solid-state battery, the second substrate is preferably a resin substrate. In addition, preferably, the first particles include at least one of active material particles and solid electrolyte particles, and the second particles include at least one of active material particles and solid electrolyte particles. More preferably, the first particles include at least one of active material particles and solid electrolyte particles, and the second particles include the other of the active material particles and the solid electrolyte particles. Still more preferably, the first particles include active material particles, and the second particles include solid electrolyte particles.

In addition, a vibration-absorbing member can be obtained by using at least one of ferroelastic particles and weakly elastic particles as the first particles and the other of the ferroelastic particles and the weakly elastic particles as the second particles. The obtained vibration-absorbing member has specificity with respect to the vibration direction.

Examples of solid-state battery precursors include a solid-state battery material layer. A material laminate can be obtained by using a solid-state battery material layer as a solid-state battery precursor and laminating the solid-state battery material layers. The solid-state battery precursor is preferably a solid-state battery electrode material layer. Therefore, the method of producing an electrode of a solid-state battery may include a step of obtaining a material layer by the above production method, a step of laminating the obtained material layers to form a laminate, and a step of removing a second substrate by heating and degreasing the obtained laminate to obtain an electrode. When the solid-state battery is formed of a single layer, the method of producing an electrode of a solid-state battery may include a step of obtaining a material layer by the above production method and a step of removing the second substrate by heating and degreasing the material layer to obtain an electrode.

That is, by removing the second substrate from the laminate, an electrode of a solid-state battery can be obtained. As the step of obtaining a laminate and the step of molding a three-dimensional object, the above steps can be used. The electrode may be a positive electrode or a negative electrode. The number of layers in the laminate is not particularly limited, and can be changed depending on the purpose of the electrode to be produced. For example, three or more layers may be used.

### EXAMPLES

The present disclosure will be described below in more detail with reference to examples, but the examples do not limit the present disclosure in any way. Here, in the following formulations, “parts” are by mass unless otherwise specified.

### Example 1

An example of preparing a positive electrode material layer of an all-solid-state battery using the material layer preparation device in FIG. 3 is shown.

A positive electrode material: lithium cobaltate (an average particle diameter of 5 μm, commercially available from Nippon Chemical Industrial Co., Ltd.) was used as first particles, a solid electrolyte: lithium borate (a target particle diameter of 5 μm, commercially available from Toshima Manufacturing Co., Ltd.) was used as second particles, a borosilicate glass (commercially available from HOYA: a thickness of 5 mm) was used as a first substrate, and a polyester film (Lumirror, a thickness of 5 μm, commercially available from Toray Industries, Inc.) was used as a mask layer. A UV laser processing machine (Micro UV laser marker, commercially available from Kokyo, Inc.) was used to form an opening in the mask, a double-sided tape (No. 5600, commercially available from Nitto Denko Corporation) was used as a second substrate, and magnetic particles (The Imaging Society of Japan: P02) were used in a particle supply unit. Then, the above first step to fifth step were performed using the material layer preparation device in FIG. 3 to prepare a positive electrode material layer of an all-solid-state battery. The mask opening pattern was a 10 μm line-and-space stripe pattern, that is, a stripe pattern with a 20 μm pitch in which the width of the opening was 10 μm and the width of the mask part was 10 μm.

Five of the prepared positive electrode material layers were laminated on an aluminum foil (thickness: 20 μm) while shifting the lamination angle by 90 degrees. Then, heating and degreasing were performed in an electric furnace (MMF-1, commercially available from As One Corporation) at 500 °C for 1 hr, and the second substrate was removed to prepare a positive electrode material layer laminate (thickness: about 25 μm) of an all-solid-state battery.

The following three items were measured to evaluate the material layer and the laminate.

### Amount of Unnecessary Particle Adhesion

The area ratio of the first particles adhered to the area that is the non-image part (the part where the mask part was removed) according to the design immediately before transfer of the particle pattern (after the third step) was optically observed. Then, the area ratio of the first particles in the non-image part was calculated using image processing software (Adobe Systems: Photoshop (registered trademark)). A total of ten material layers were prepared in the same manner, and the arithmetic mean value of the obtained area ratios of the first particles was taken as the amount of unnecessary particle adhesion. The amount of unnecessary particle adhesion was 0 area %.

### Particle Transfer Rate

The mass of the first particles adhered to the second substrate after transfer and the mass of the first particles held on the first substrate immediately before transfer were measured using an electronic balance (commercially available from As One Corporation). In each measurement, values were rounded up to four decimal places, with the five decimal places rounded off. Then, the value was obtained by the following formula.

The mass (g) of the first particles adhered to the second substrate after transfer/the mass (g) of the first particles held on the first substrate immediately before transfer×100

A total of ten material layers were prepared in the same manner, and the arithmetic mean value of the values obtained by the above formula was taken as the particle transfer rate. The particle transfer rate was 99.2%.

Variation Range of Electrical Resistance Value in Thickness Direction of Positive Electrode Material Layer Laminate

The variation range of the electrical resistance value in the thickness direction of the obtained positive electrode material layer laminate was measured. A 1255WB model (commercially available from Solartron) was used as an electrochemical device. A total of ten laminates were prepared in the same manner, the electrical resistance value of each laminate was measured using the electrochemical device, and the arithmetic mean value of the obtained electrical resistance values was determined. Then, the variation range of the electrical resistance value was determined by the following formula using the arithmetic mean value and an electrical resistance value A, which is the value most distant from the obtained arithmetic mean value among the electrical resistance values of the ten laminates in total.

|Electrical resistance value A (Ω)-arithmetic mean value of the electrical resistance value (Ω)|/arithmetic mean value of the electrical resistance value (Ω)×100

The variation range of the electrical resistance value was 1.75%.

According to the above evaluation, no transfer failure was observed in the prepared material layer, and the quality of the prepared laminate was also stable.

### Comparative Example 1

A positive electrode material layer of an all-solid-state battery was prepared under the same conditions as in Example 1 except that, without using the first substrate and the mask layer, a glass intaglio plate prepared by patterning a borosilicate glass (HOYA: a thickness of 5 mm) with a photoresist and then performing dry etching to form the same pattern (a plate depth of 5 μm) as in Example 1 was used. In addition, a positive electrode material layer laminate of an all-solid-state battery was prepared under the same conditions as in Example 1. Then, evaluation was performed in the same manner as in Example 1. The evaluation results are shown in Table 1.

TABLE 1

| | | Evaluation results | | |
|---|---|---|---|---|
| | | Amount of | | Variation |
| | | unnecessary | Particle | range of |
| | Method of producing | particle | transfer | electrical |
| | material layer | adhesion | rate | resistance |
| Example 1 | Method of present | 0 area % | 99.2% | 1.75% |
| | disclosure | | | |
| Comparative | Existing public | 4.6 area % | 96.3% | 6.13% |
| Example 1 | technique using glass | | | |
| | intaglio plate | | | |

### Example 2

An example of preparing a vibration-absorbing rubber material layer using the material layer preparation device in FIG. 3 is shown.

Ferroelastic particles: cross-linked polyacrylic acid ester (ARX-30, commercially available from Sekisui Kasei Co., Ltd.) were used as first particles, weakly elastic particles: cross-linked acrylic monodisperse particles (MX-3000, commercially available from Soken Chemical & Engineering Co., Ltd.) were used as second particles, a borosilicate glass (commercially available from HOYA: a thickness of 5 mm) was used as a first substrate, and SUS430 (a thickness of 30 μm) was used as a mask layer. A CO2 laser processing machine (commercially available from Kokyo, Inc.) was used to form an opening in the mask, a double-sided tape (No. 5600, commercially available from Nitto Denko Corporation) was used as a second substrate, and a forward-rotating roller unit including a urethane rubber roller (a rubber hardness of 70 degrees) was used as a particle supply unit. Then, the above first to fifth steps were performed using the material layer preparation device in FIG. 3 to prepare a vibration-absorbing rubber material layer. The mask opening pattern was a 100 μm line-and-space stripe pattern, that is, a stripe pattern with a 200 μm pitch in which the width of the opening was 100 μm and the width of the mask part was 100 μm.

In addition, during the period from the first step to the third step, a magnet was arranged on the back surface of the intermediate transfer member to hold the mask layer and the mask part with a magnetic force.

In order to evaluate the material layer, the amount of unnecessary particle adhesion described above and the particle transfer rate were evaluated. The results are shown in Table 2. No transfer failure was observed in the prepared material layer, and stable quality was achieved.

Here, a vibration-absorbing rubber material laminate obtained by repeatedly laminating 150 of the prepared vibration-absorbing rubber material layers in the order of 0°, 0°, and 90° was able to be produced with stable quality as a vibration-absorbing member having specificity with respect to the vibration direction. Here, the specificity with respect to the vibration direction indicates that the amount of deformation when the laminate was subjected to vibration was not isotropic. Specifically, in the stripe pattern, the amount of deformation was small in the longitudinal direction with respect to the vibration direction, and the amount of deformation was large in the short direction with respect to the vibration direction.

### Comparative Example 2

A vibration-absorbing rubber material layer was prepared under the same conditions as in Example 2 except that, without using the first substrate and the mask layer, a PDMS intaglio plate (produced in-house) prepared by casting onto a master mold processed by a precision lathe into the same pattern (a plate depth of 30 μm) as in Example 2 was used. In addition, evaluation was performed in the same manner as in Example 2. The evaluation results are shown in Table 2.

TABLE 2

| | | Evaluation results | |
|---|---|---|---|
| | | Amount of | Particle |
| | Method of producing | unnecessary | transfer |
| | material layer | particle adhesion | rate |
| Example 2 | Method of present | 0 area % | 99.6% |
| | disclosure | | |
| Comparative | Existing public | 2.3 area % | 84.7% |
| Example 2 | technique using | | |
| | PDMS intaglio plate | | |

The present disclosure provides a method of producing a material layer that contributes to stabilizing production quality and improving the yield rate. In addition, the present disclosure provides a method of producing a precursor of a solid-state battery that contributes to stabilization of production quality and improving the yield rate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A method of producing a material layer, comprising:
a first step of forming a mask part on a part of a surface of a first substrate;
a second step of arranging first particles on the surface of the first substrate;
a third step of removing the mask part from the first substrate;
a fourth step of transferring the first particles to a second substrate; and
a fifth step of arranging second particles on at least a part of a region of a surface of the second substrate where the first particles are not arranged.

2. The method of producing the material layer according to claim 1, wherein the first step comprises a step of providing a mask layer on the first substrate and a step of forming an opening in the mask layer to form the mask part.

3. The method of producing the material layer according to claim 1, wherein the second step is a step of arranging first particles in a region of the surface of the first substrate where the mask part is not formed.

4. The method of producing the material layer according to claim 1,
wherein the first particles comprise at least one of active material particles and solid electrolyte particles, and
the second particles comprise at least one of active material particles and solid electrolyte particles.

5. A method of producing a precursor of a solid-state battery, comprising the method of producing the material layer according to claim 4,
wherein the second substrate is a resin substrate.
